(19) United States
(12) Patent Application Publication
(10) Pub. No.: US 2002/0194078 A1
(43) Pub. Date: Dec. 19, 2002

(54) Hot sync through POS terminal

(76) Inventors: Jean-Marc Villaret, Paris (FR); Stuart Taylor, Cupertino, CA (US); Kevin F. Ritschel, San Jose, CA (US)

Correspondence Address: HEWLETT-PACKARD COMPANY, Intellectual Property Administration, P.O. Box 272400, Fort Collins, CO, 80527-2400, US

(21) Appl. No.: 09/882,955

(22) Filed: Jun. 15, 2001

(51) Int. Cl. G06F 17/60

(52) U.S. Cl. 705/26

(57) ABSTRACT

A system and method for enabling a merchant to connect electronically to the customer, specifically the customer's portable digital appliance, from the merchant's point of sale (POS) terminal, thereby providing “last meter connectivity”. That is, the consumer can synchronize or download data onto (or off of) his/her portable appliance from (to) any public device, such as the POS terminal.

### RELATED APPLICATIONS

The present application is related to commonly assigned, co-pending, and concurrently filed U.S. patent application Ser. No. [Attorney Docket No. 10013451-1] entitled “SYSTEM AND METHOD FOR PROVIDING E-SERVICES,” the disclosure of which is hereby incorporated herein by reference.

### TECHNICAL FIELD

The present invention relates to a system and method for synchronizing a portable digital appliance with a point of sale (POS) terminal.

### BACKGROUND

Only a decade ago, a merchant could accept a single type of credit card and satisfy most customers. That has changed dramatically with the proliferation of card-based payment, payment-related and even non-payment options in the highly competitive retail marketplace. This has added significantly to the complexity of today's e-payment environment.

Merchants are always looking for new ways to enhance convenience and increase sales, while reducing costs. As point of sale (POS) terminals have become more powerful and sophisticated, they offer the potential to move into the mainstream of retail operations, such as providing a way to capitalize on untapped opportunities by supporting an array of value-added, non-payment applications. This changing environment has created a need for merchants to connect electronically to customers at their point of sale terminals to provide “last meter of connectivity”.

### SUMMARY OF THE INVENTION

The present invention is directed to a system and method for synchronizing information stored in a portable appliance with information stored in an e-server through a POS terminal and across a network. The consumer establishes a wireless connection between the consumer's portable device and the POS terminal and initiates a synchronization process in the portable appliance to synchronize information stored in the portable appliance with information stored in the desired e-service server via the POS terminal.

### BRIEF DESCRIPTION OF THE DRAWING

FIG. 1 shows a block diagram showing the incorporation of the present invention within a point and pay system or environment; and

FIG. 2 shows a block diagram of one operational embodiment of the invention.

### DETAILED DESCRIPTION

The present invention is readily implemented by presently available communication apparatus and electronic components. The invention finds ready application in virtually all commercial communication networks, including but not limited to a telephone network, wireless network, local area network (LAN), wide area network (WAN), intranet, world wide web (Internet), and wired cable transmission system.

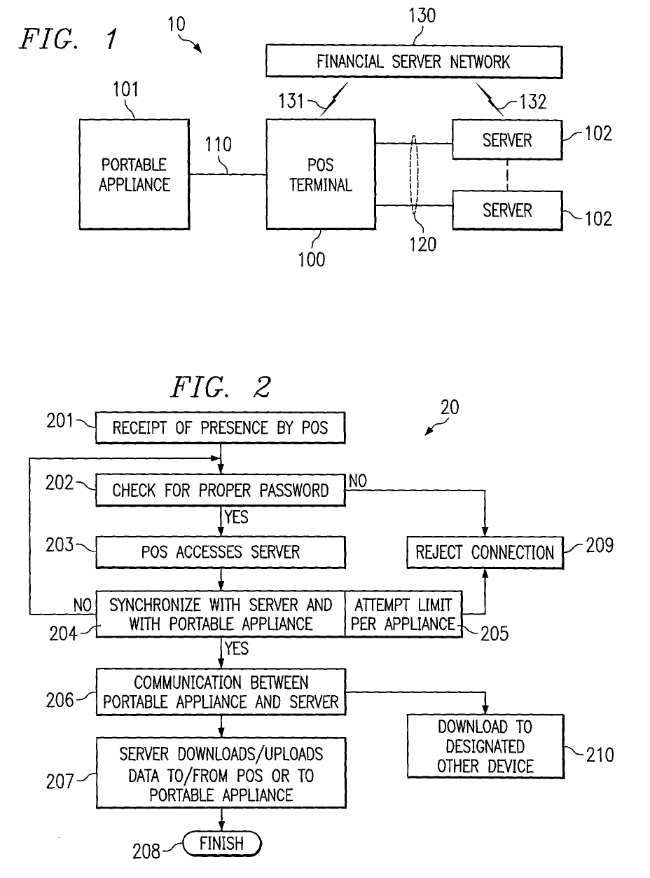

FIG. 1 shows system 10 having POS terminal 100 operable to support synchronization with consumer portable appliance 101, such as a cell phone, personal digital assistant (PDA), beeper or digital device via a wireless connection. The customer can connect portable appliance 101 to POS terminal 100 via a wireless connection, such as connection 110 and synchronize, i.e., Hot Sync, portable appliance 101 with web-based services or accept delivery of digital information/products (collectively referred to herein as “e-services”). POS terminals 100 are often coupled together into computer networks, such as a secured financial network 130 and/or Internet. This connection can be wired or wireless, such as shown by 131. When POS terminal 100 is used to synchronize portable appliance 101 to a server, the network infrastructure can be used via 132 to route a synchronization to the appropriate e-service provider or server 102. For example, the consumer generally stores his/her personal information, such as address information, credit card information, a list of preferred e-service providers with status of any outstanding orders, etc. on a server, such as server 102 which then can be accessed via POS terminal 100. Alternatively, POS terminal 100 can access server(s) 102 by a direct (or daisy chained) link 120 if desired. Any of the links, or portions thereof, can be wired or wireless. Link 120 can, if desired, be the Internet.

Accordingly, the consumer can synchronize his/her portable device 101 using POS terminal 100 as a communication medium. To perform this synchronization across the network, such as the Internet, via POS terminal 100, portable appliance 101 generally stores an identifier that can be used to uniquely address and identify portable appliance 101 across the Internet via POS terminal 100.

In accordance with an embodiment of the present invention, the consumer can synchronize his/her portable appliance 101 by establishing a wireless connection with POS terminal 100. In accordance with an aspect of the present invention, POS terminal can verify if the consumer or portable appliance 101 is authorized to access the POS terminal using any known techniques. The wireless connection can be established using any known techniques, including but not limited to wireless application protocol (WAP), shared wireless access protocol, wireless LAN or WLAN, IrDA, bluetooth, PAN, etc. Bluetooth is a short-range radio technology aimed at simplifying communications among net devices and between devices and the Internet. IrDa is short for Infrared Data Association, a group of device manufacturers that developed a standard for transmitting data via infrared light waves. Personal Area Network (PAN) is an IBM technology based on the electric-field transmission medium that allows individuals to exchange data with a simple touch or grasp. In accordance with an aspect of the present invention, POS terminal 100 is connected to one or more back end servers 102 to provide requested e-services, contents, etc. over the intranet or Internet. It is appreciated that POS can be connected to back end server(s) 102 over a wired or wireless connection.

After establishing a wireless connection with POS terminal 100, the consumer can “Hot Sync” his/her portable appliance 101 to web-based services to accept the delivery of digital information/products. It is appreciated that the e-services can include subscribed services, such as connecting to an ISP (i.e., AOL), electronic payment services, receiving email, etc. Also, e-services include, but are not limited to, e-reservation services wherein the consumer can make reservations for a restaurant, e-takeout services wherein the consumer can order food for takeout and/or delivery, e-ticketing services wherein the consumer can purchase tickets for a concert, a sporting event, a movie, etc. Further, the consumer can use the e-services to purchase CDs, DVDs, wherein the desired movie, song, or album is downloaded onto a CD or DVD, electronic books, pre-paid telephone cards, and the like. Accordingly, for example, the consumer can initiate the synchronization process by pressing a predetermined button on portable appliance 101 or activating a synchronization software resident in portable appliance 101.

Using the identifier that uniquely addresses or identifies the e-service provider or server 102, the synchronization software in POS terminal attempts to reach the desired e-service server 102 across the network. If the synchronization software in POS terminal 100 can reach the desired e-service server 102 through the network, then the synchronization software in POS terminal 100 acts as a pass-through and allows the synchronization software in portable appliance 101 to perform the synchronization with e-service server 102. For example, the consumer can synchronize with e-service server 102 to receive or download the ordered movie, album, music, etc. or status of an outstanding order. The invention may also be used to pay for a good or service, and can receive a receipt for the payment. The receipt may be stored on the device or on a server based wallet.

Turning now to FIG. 2, there is shown one embodiment of a system such as system 20 which shows POS 100 in step 201 receiving a signal from a portable device, such as device 101 in FIG. 1. Once POS 100 receives a signal, step 202 checks for a proper password and exchanges information so that it is satisfied that terminal 101 is a proper terminal for accessing a server. If this password is rejected, then step 209 rejects the connection and communicates that information back to user. If the password is acceptable, then step 203 provides an access to server 102. The server can be selected either by POS terminal 100, or more likely, it would be selected based upon the password identification information accepted from portable appliance 101.

As discussed previously, this connection can be made directly via network 120 from POS terminal 100 or via network 131 through the financial services network and over connection 132 to a selected server or e-services provider. In some cases, the e-services provider would be selected by POS terminal 100 depending upon its network or selected based upon, as discussed above, the identification information from the customer's portable appliance. Once the server or e-services is connected, step 202 begins a synchronization process to synchronize server 102 with portable appliance 101 and the synchronization, if desired, can have several attempts and if the limit of attempts have been exceeded and synchronization is not achieved, then the connection is rejected via step 205 and 209.

If synchronization is achieved, then communication between the portable appliance and the server as to what information or products or data is desired (or the server can provide portable appliance 101 with information that it deems necessary). Once this communication takes place, step 207 controls the downloading or uploading of information between the various elements in the systems, such as portable appliance 101, POS terminal 100, and server 102. Of course, the system can offer to obtain information from financial services network 130 and embed that information into the transaction.

For example, if the customer desired to download a DVD into a hand held or portable device connected to POS terminal 100, the financial services network 130 could control the payment for the transaction or could control appropriate approval levels if necessary. Once the downloading or uploading is finished, then the system can be disconnected under control of step 208. Also note that the portable device can, if desired, designate a separate device for receiving the information from the server as controlled by step 210.

Therefore, the present invention advantageously enables the consumer to synchronize or download onto his/her portable appliance 101 from any public device, such as a POS terminal, a kiosk, a credit card swiper, a credit card authorization device, an electronic fund transfer point of sale device (EFTPOS), etc. That is, the present invention overcomes the limitations of the prior art system, wherein the consumer downloads or synchronizes his/her portable appliance 101 using a physical docking station connected to the consumer's private PC.

What is claimed is:

1. A method for interchanging information between a portable appliance and a database, said system comprising the steps of:
establishing a wireless connection between said portable appliance and a POS terminal, said POS terminal being connectable to a plurality of e-service servers over a network; and
initiating a synchronization process between said portable appliance and a connected server to synchronize information stored in said portable appliance with information stored in said connected server via said POS terminal.

2. The method of claim 1 wherein said synchronization step includes the steps of:
locating a proper one of said e-service servers on said network; and
interchanging unique identify codes between said portable appliance, said POS terminal and said connected server.

3. The method of claim 1 wherein the selection of a proper server depends, at least in part, on a unique identity code of said portable appliance.

4. The method of claim 1 wherein said network is an Internet.

5. The method of claim 1 wherein said portable appliance comprises at least one of the following: a cell phone, a PDA, and a beeper.

6. The method of claim 1 wherein the step of synchronizing includes the step of downloading digital content.

7. The method of claim 6 wherein said digital content comprises at least one of the following: email, music, movie, ticket, and electronic books.

8. The method of claim 1 wherein the step of establishing the wireless connection includes the step of verifying if said portable appliance is authorized to access said POS terminal.

9. A system for synchronizing information on a portable appliance, comprising:
a network;
a plurality of e-services available to said network; and
at least one POS terminal connectable said e-service servers over said network;
wherein said portable appliance establishes a wireless connection with said POS terminal and initiates a synchronization process to synchronize information stored in said portable appliance with information stored in at least one e-service server via said POS terminal.

10. The system of claim 9 wherein said POS terminal establishes the wireless connection with said portable appliance if it is determined that said portable appliance is authorized to access said POS terminal.

11. The system of claim 9 wherein said POS terminal is operable to locate said at least one e-service server on said network to synchronize said information stored in said portable appliance with said information stored in said e-server.

12. The system of claim 9 wherein said network is an Internet.

13. The system of claim 9 wherein said portable appliance comprises at least one of the following: a cell phone, a PDA, and a beeper.

14. The system of claim 9 wherein the step of synchronizing includes the step of downloading digital content.

15. The system of claim 14 wherein said digital content comprises at least one of the following: email, music, movie, ticket, receipt, and electronic books.

16. A system for controlling the interchange of data when a portable device associated with a user, said system comprising:
means for temporarily interchanging information between one of said user devices and a POS terminal; and
means controlled by said POS terminal as a result of said interchange of information with a specific portable device for establishing a communication connection between said specific device and a particular remote e-services facility.

17. The system set forth in claim 16 further comprising means for allowing data exchange between said particular user device and said particular e-services facility via said POS terminal.

18. The system set forth in claim 16 further comprises means for allowing data exchange between said particular e-services facility and a designated receiving device, said receiving device designated by said particular user device via said POS terminal.

19. The system set forth in claim 16 wherein said e-services facility is selected from one of a database, server, communication network, or terminal network.
